(19) United States
(12) Patent Application Publication
(10) Pub. No.: US 2013/0204658 A1
(43) Pub. Date: Aug. 8, 2013

(54) SYSTEM AND METHOD FOR IMPROVING EFFECTIVENESS OF INTERNET MARKETING

(71) Applicant: SociaLasso, Tel Aviv (IL)

(72) Inventors: Guy Yogev, Tel Aviv (IL); Nir Cohen, Tel Aviv (IL); Gideon Cohen, Tel Aviv (IL); Nimrod Shaulski, Kfar Saba (IL)

(73) Assignee: SociaLasso, Tel Aviv (IL)

(21) Appl. No.: 13/753,885

(22) Filed: Jan. 30, 2013

Related U.S. Application Data
(60) Provisional application No. 61/595,018, filed on Feb. 3, 2012.

(51) Int. Cl. G06Q 30/02

(52) U.S. Cl. CPC G06Q 30/0201
USPC 705/7.29

(57) ABSTRACT

A system for improving effectiveness of Internet marketing contains a memory and a processor configured by the memory to perform the steps of: assuming that all entities within a beginning entity list are from a first social product market network; determining information about at least one entity of the beginning entity list that can be tracked on the Internet by following a footprint of the at least one entity; running a qualification process on each new entity, attribute, and/or link discovered during following of the footprint of the at least one entity of the beginning entity list to validate relevance of the new entity, attribute, and/or link discovered to the product market network of the beginning entity list; storing entities, attributes, and/or links determined to be relevant during the step of running a qualification process; determining information about the new entity by tracking the information on the Internet and following a footprint of the new entity; and running a qualification process on each additional new entity, attribute, and/or link discovered during following of the footprint of the new entity.

### CROSS-REFERENCE TO RELATED APPLICATION

This application claims priority to copending U.S. Provisional application entitled, “SYSTEM AND METHOD FOR IMPROVING EFFECTIVENESS OF INTERNET MARKETING,” having Ser. No. 61/595,018, filed Feb. 3, 2012, which is entirely incorporated herein by reference.

### FIELD OF THE INVENTION

The present invention is generally related to social media analysis and internet marketing, and more particularly is related to a system and method for increasing social media marketing and management effectiveness.

### BACKGROUND OF THE INVENTION

The Internet, and especially Web based social media, has become a major playground for marketing activities. Examples of Web based social media include social networks and other social platforms provided over the Internet. Marketers who are active in social media are facing a significant challenge in finding the most relevant information within the large amount of user generated content and communications. Relevant information is defined as information that is valuable to marketers for capitalizing on marketing efforts.

For purposes of finding and arranging the relevant information, such as, posts, events, blogs, discussion groups and influencers, marketers currently use available social media listening tools and monitoring software tools or perform these tasks manually either by internal employee or external service provider using human judgment.

An example of such a tool is a keyword based search engine for social media (“Social monitoring Engine”). Such a social monitoring engine is capable of taking a search term and determining numerous elements associated with the search term. As an example, a social monitoring engine may allow entry of a search term. In return, the social monitoring engine returns to the user specific content or influencers within a Web site. An influencer is a person whose views and opinions are considered as valuable to other people in the same social ecosystem. These social media listening tools and monitoring software tools only manage to reduce a small portion of data that is irrelevant or missing relevant data. This challenge is also relevant to many types of organizations such as government agencies and researchers that want to understand, as well as to influence, social media.

With the number of search results being so voluminous, social monitoring and listening engines are not useful in maximizing marketing efforts so as to allow for maximum exposure and influence with minimal resources. In addition, these tools are inefficient in defining a center of activities (namely, a group of entities that most of the social ecosystem information passes through, or that creates the social ecosystem information) and reflects the evolving dynamics of the information.

Thus, a heretofore unaddressed need exists in the industry to address the aforementioned deficiencies and inadequacies.

### SUMMARY OF THE INVENTION

Embodiments of the present invention provide a system and method for improving effectiveness of Internet marketing. Briefly described, in architecture, one embodiment of the system, among others, can be implemented as follows.

A system for improving effectiveness of Internet marketing contains a memory and a processor configured by the memory to perform the steps of: assuming that all entities within a beginning entity list are from a first social product market network; determining information about at least one entity of the beginning entity list that can be tracked on the Internet by following a footprint of the at least one entity; running a qualification process on each new entity, attribute, and/or link discovered during following of the footprint of the at least one entity of the beginning entity list to validate relevance of the new entity, attribute, and/or link discovered to the product market network of the beginning entity list; storing entities, attributes, and/or links determined to be relevant during the step of running a qualification process; determining information about the new entity by tracking the information on the Internet and following a footprint of the new entity; and running a qualification process on each additional new entity, attribute, and/or link discovered during following of the footprint of the new entity.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram illustrating information flow in accordance with the present system and method.

FIG. 2 is a schematic diagram providing an example of a network in which the present system and method may be implemented.

FIG. 3 is a schematic diagram further illustrating the Web server of FIG. 1.

FIG. 4 is a flow chart illustrating the general process used by the present system, in accordance with the first exemplary embodiment of the invention.

### DETAILED DESCRIPTION

The present system and method provides understanding of social media structure for a given product market or topic as it exists on the Internet so as to better determine and understand the flow of relevant information and capitalize on such relevant information for marketing purposes (i.e., for understanding and/or influencing audiences of interest). Relevant information is determined and utilized to provide an entity, destination, or information for purposes of marketing for maximum return on investment. The present system and method determines the relevant information by determining and revealing who are the key players for a specific market, what are the major forums used, who has strong influence on whom in the specific market, and who should be influenced next or what relationship should be maintained.

One of the ways to uncover a Social Media structure is to follow the relevant information flow as it runs through the different entities in a specific product market network (ecosystem). The relevant information flow shows which of the entities is an information junction, meaning that most of the information is getting to a specific entity and front there it is forwarded or replied to by the entity. In addition, the information flow allows an evaluation of links between the entities. For example, a very strong link (big pipe) would be a link between two entities having a great deal of information passing therethrough, where the information is of high quality, meaning that for most people (and other entities) in the same ecosystem, the information is important and valuable. Each of the entities in an ecosystem can be an amplifier of the information to another entity in the ecosystem meaning that the entity makes the information passing through it more accessible and more influencing. The entity can instead be an attenuator to other entities where the information passed has little or no effect on other entities in the ecosystem by either not receiving the information, not being influenced by the information, or by not passing the information on to other entities. As an example, if a first entity is passing data to a new person in the ecosystem (a second entity) who has no connection to other entities in the ecosystem, then the data passed cannot go further from the second entity. Therefore, the new person (second entity) is attenuating the data flow to halt.

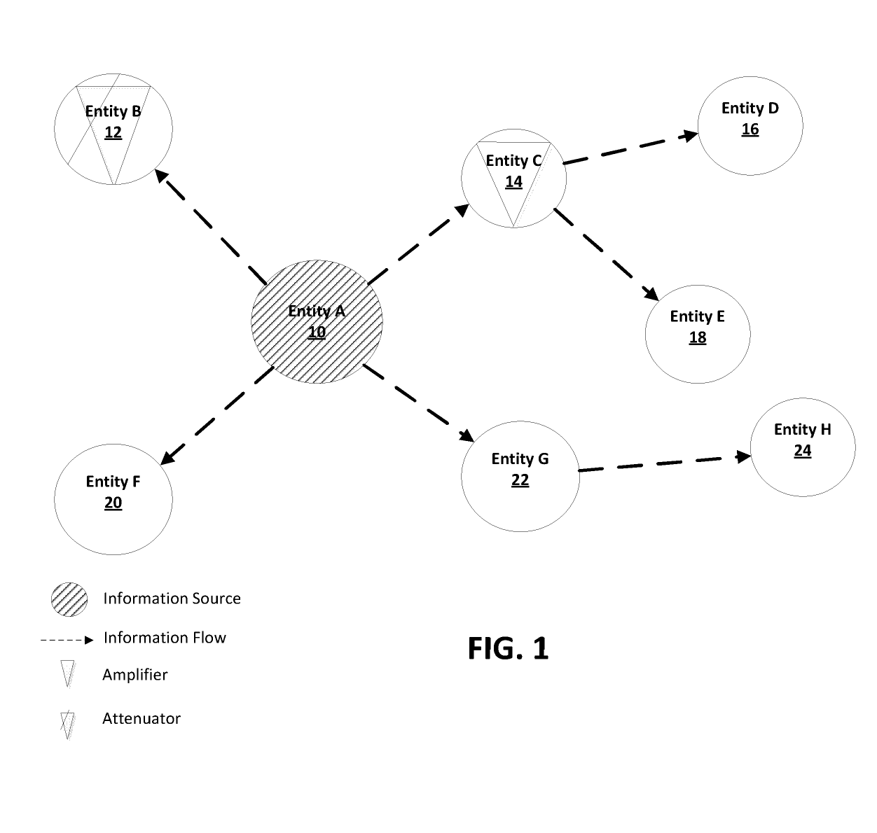

FIG. 1 is a schematic diagram illustrating information flow, in accordance with the present invention. As shown by FIG. 1, Entity A (10) is the information source of content that leads to information flow from Entity A to other entities in the ecosystem. The content can be for example a blog post, a retweet of a Twitter message or a “Like” on another entity post. The entities connected to Entity A (10), specifically, Entities B (12), C (14), F (20) & G (22) are getting the information (receiving entities) and either end the flow or forward the information (continue the flow) to other connected entities. If the receiving entity manages to forward the content to many other entities and/or to enrich the original content, then the receiving entity is acting as an amplifier. In the example of FIG. 1, Entity C (14) is acting as an amplifier since it is forwarding the content to multiple entities.

If the receiving entity either stops or reduces the flow, then the entity is acting as an attenuator. In the example of FIG. 1, Entity (12) is acting as an attenuator. Meaning that the information Entity B (12) received from Entity A (10) is not reaching to any other entity in the ecosystem. As more information is flowing through the entities the strength of each entity as an amplifier or attenuator in the specific ecosystem can be dynamically evaluated.

The present system and method provides for extracting relevant information, processing the information, and effectively using the information so as to help marketers facing marketing challenges. Understanding of social media activity for a given product market is enabled by the building of a network model having many entities that are of different types and links between the entities. Herein, examples of types of entities may include, but are not limited to, web locations such as, but not limited to, blogs and discussion groups represented by universal resource locations (URLs)), people, companies, government agencies, events, and associations. It should be noted that in accordance with the present system and method, an entity is an object that is presented in social media and can create information, store it and distribute it to other entities at its original form, after changing it or, after adding additional information to the original information.

The present system and method is designed to recognize different types of entities, including, but not limited to, the above-mentioned entity examples and to discover the links between the entities. In addition, a product market may be defined as potential customers sharing a particular need, all of the vendors that satisfy this need, and the social relationships between them and other mediating entities. Herein, customers can also be considered as those looking for information in a specific field even if there is no intent to purchase a concrete good or service. As an example, a product market for dog training only deals with exchanging information, however, it is still referred to herein as a product market. Herein, a mediating entity is an entity that is neither a vendor nor a customer, however the mediating entity is active in the specific product market. A mediating entity can be, for example, a professional association that is active in a specific product market.

The present system and method also determines and uses key attributes of each entity, which enables understanding the social role of the entity and its location in the product market network. The location of an entity is defined when the mathematical model of a product market is visualized, as is described in detail below. The social role of an entity is a combination of the entity activity, volume in social media, the quality of information it creates, and the stimulation it produces on other entities in the social ecosystem (also referred to herein as calculated attributes). For each type of entity there are different attributes. Attributes are divided into, but not limited to, two types, namely, informative attributes, which provide information on the entity, and calculated attributes, which describe the strength or value of the entity in the product market network. Examples of informative attributes include, but are not limited to, for a company type entity—company's name, Web site, company page in social networks such as, but not limited to, Linkedin and Facebook, number of employees, public or private, NSDQ symbol, etc., and for a person type entity—person name, job title, company he/she works for, email address, telephone number, Facebook page, Linkedln profile, Twitter account, etc.

For exemplary purposes, there may be three types of calculated attributes, although the present invention is not limited to three. These three include:

1. Volume—how active is the entity in the product market

2. Quality how professional and valuable is the content produced by the entity

3. Stimulation—the strength of other entities reaction to the specific content of the entity

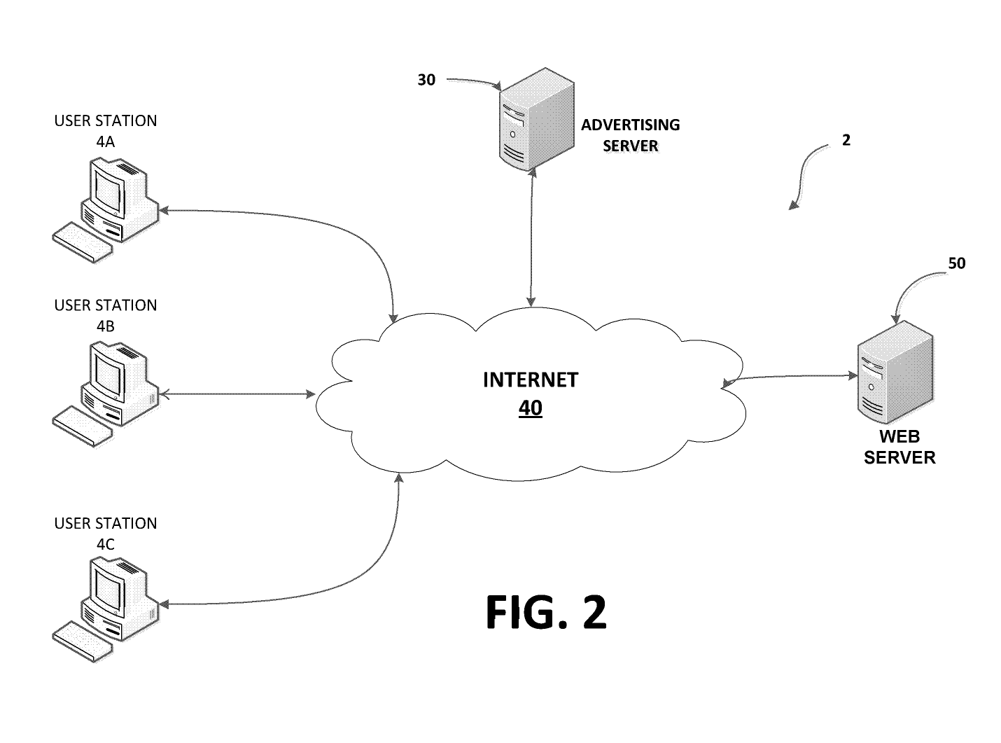

FIG. 2 is a schematic diagram providing an example of a network 2 in which the present system and method may be implemented. It should be noted that FIG. 2 is provided for exemplary purposes and is not intended to limit location and implementation of the present system and method. As shown by FIG. 2, the network 2 contains a series of client stations 4A, 4B, 4C, an advertising server 30, and a Web server 50, each of which is capable of communication via the Internet 40 or via another data communication means.

An example of a client station 4 may be, but is not limited to, a computer or any other device having a memory and a processor. Examples of client stations may include, but are not limited to, laptop computers, desktop computers, personal data assistants, mobile telephones, or any other device having the capability of allowing a client/user to interact with the Internet. It should be noted that three client stations 4 are illustrated by FIG. 2 merely for exemplary purposes. As is known by those having ordinary skill in the art, a network 2 may have any number of client stations 4. In addition, a client station 4 allows a user to make a request for access to the Internet, such as, but not limited to, for purposes of accessing a Web site. As a result, the client station 4 allows the user to view content stored at a remote location, such as, for example, at the Web server 50.

The advertising server 30 is a server containing advertisements for posting on the Internet. In addition, the Web server 50 is a server that assists with the delivery of content on the Internet, for example, via a Web site. As is explained in further detail herein, functionality of the present system and method is stored on the Web server 50.

While the present description provides the example of functionality of the system and method being stored within software of the Web server 50, it should be noted that this is not intended to be a limitation to the present invention. Instead, the functionality may be stored at a different location, such as, but not limited to, at a user station 4. In addition, while the present description provides the example of the Web server 50 and advertising server 30 being separate servers, one having ordinary skill in the art would appreciate that content and functionality of each server may be provided within a single server, two servers, or any number of servers.

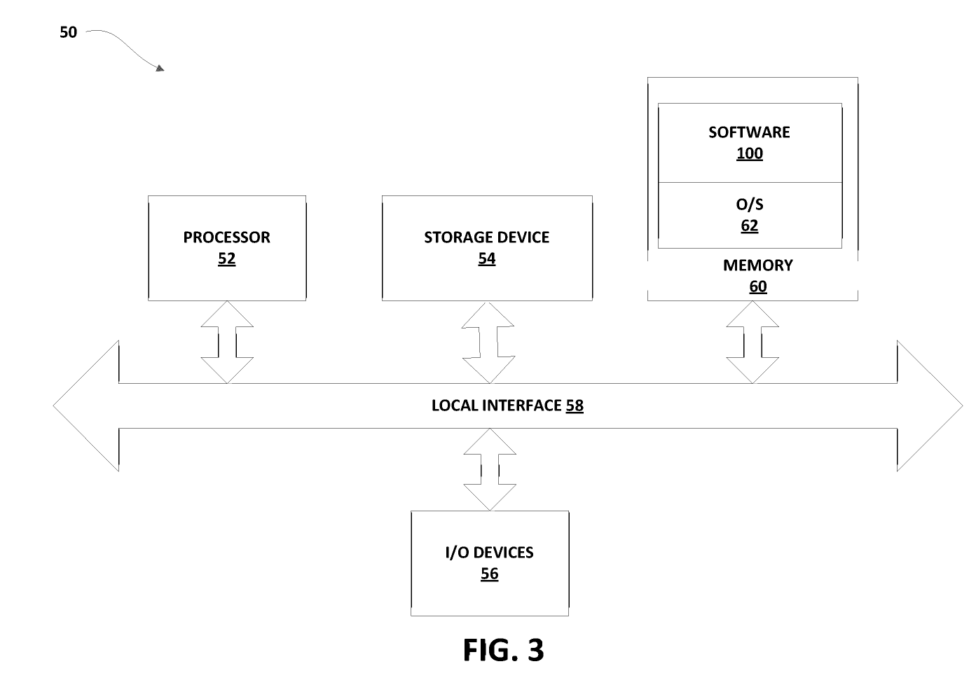

FIG. 3 is a schematic diagram further illustrating the Web server 50 of FIG. 2. Functionality of the present system and method can be implemented in software, firmware, hardware, or a combination thereof. In a first exemplary embodiment, a portion of the present system is implemented in software, as an executable program, and is executed by the Web server 50. It should be noted, however, that the software may be stored on any special or general-purpose digital computer, such as, but not limited to, a personal computer, workstation, minicomputer, or mainframe computer.

Generally, in terms of hardware architecture, as shown in FIG. 3, the Web server 50 includes a processor 52, memory 60, storage device 54, and one or more input and/or output (I/O) devices 56 (or peripherals) that are communicatively coupled via a local interface 58. The local interface 58 can be, for example but not limited to, one or more buses or other wired or wireless connections, as is known in the art. The local interface 58 may have additional elements, which are omitted for simplicity, such as controllers, buffers (caches), drivers, repeaters, and receivers, to enable communications. Further, the local interface 58 may include address, control, and/or data connections to enable appropriate communications among the aforementioned components.

The processor 52 is a hardware device for executing software, particularly that stored in the memory 60. The processor 52 can be any custom made or commercially available processor, a central processing unit (CPU), an auxiliary processor among several processors associated with the server 50, a semiconductor based microprocessor (in the form of a microchip or chip set), a macroprocessor, or generally any device for executing software instructions.

The memory 60 can include any one or combination of volatile memory elements (e.g., random access memory (RAM, such as DRAM, SRAM, SDRAM, etc.)) and nonvolatile memory elements (e.g., ROM, hard drive, tape, CDROM, etc). Moreover, the memory 60 may incorporate electronic, magnetic, optical, and/or other types of storage media. Note that the memory 60 can have a distributed architecture, where various components are situated remote from one another, but can be accessed by the processor 52.

Software 100 in the memory 60 may include one or more separate programs, each of which contains an ordered listing of executable instructions for implementing logical functions of the present marketing system, as described below. In the example of FIG. 3, the software 100 in the memory 60 defines the functionality in accordance with the present invention. In addition, the memory 60 may contain an operating system (O/S) 62. The operating system 62 essentially controls the execution of computer programs and provides scheduling, input-output control, file and data management, memory management, and communication control and related services.

The present system may be provided by a source program, executable program (object code), script, or any other entity containing a set of instructions to be performed. When a source program, then the program needs to be translated via a compiler, assembler, interpreter, or the like, which may or may not be included within the memory 60, so as to operate properly in connection with the O/S 62. Furthermore, the present system can be written as (a) an object oriented programming language, which has classes of data and methods, or (b) a procedure programming language, which has routines, subroutines, and/or functions.

The I/O devices 56 may include input devices, for example but not limited to, a keyboard, mouse, scanner, microphone, etc. Furthermore, the I/O devices 56 may also include output devices, for example but not limited to, a printer, display, etc. Finally, the I/O devices 56 may further include devices that communicate via both inputs and outputs, for instance but not limited to, a modulator/demodulator (modern; for accessing another device, system, or network), a radio frequency (RF) or other transceiver, a telephonic interface, a bridge, a router, etc.

When the present system is in operation, the processor 52 is configured to execute the software 100 stored within the memory 60, to communicate data to and from the memory 60, and to generally control operations of the server 50 pursuant to the software 100. The software 100 and the O/S 62, in whole or in part, but typically the latter, are read by the processor 52, perhaps buffered within the processor 52, and then executed.

When the present system is implemented in software, as is shown in FIG. 3, it should be noted that the present system can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The present system can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CC ROM) (optical). Note that the computer-readable medium could even be paper or another suitable medium upon which the program is printed, as the program can be electronically captured, via fix instance optical scanning of the paper or other medium, then compiled, interpreted or otherwise processed in a suitable manner if necessary, and then stored in a computer memory.

In an alternative embodiment, where the present system is implemented in hardware, the system can be implemented with any or a combination of the following technologies, which are each well known in the art: a discrete logic circuits) having logic gates for implementing logic functions upon data signals, an application specific integrated circuit (ASIC) having appropriate combinational logic gates, a programmable gate array(s) (PGA), a field programmable gate array (FPGA), etc.

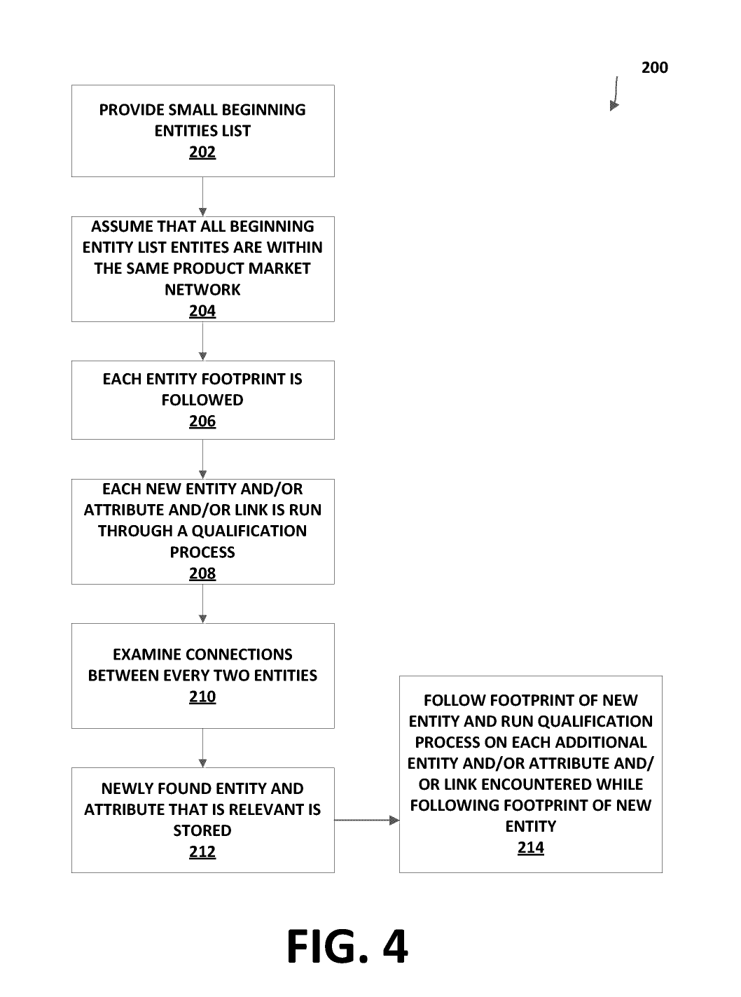

FIG. 4 is a flow chart 200 illustrating the general process used by the present system, in accordance with the first exemplary embodiment of the invention. It should be noted that any process descriptions or blocks in flow charts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

As shown by block 202, a relatively small entities list is provided, referred to herein as a beginning entities list. The beginning entities list is a starting list of entities to be analyzed in accordance with the present invention, as is explained in further detail hereinbelow. Comparatively speaking, the term small herein refers to a few entities (for example, 2-3 entities is good enough, although the present system and method is not limited to this number), which may be selected from 2-3 types of entities (again, although the present system and method is not limited to this number). For example, the beginning entities list may include 3 people, 2 companies and 3 associations that are known to be part of the specific product market network that the user is interested in.

As shown by block 204, it is assumed that each entity within the beginning entities list is within the same product market network.

The Product market networks are distinguished by a combination of several elements, such as, but not limited to:
1. The international definition of the product market network: several external international standard bodies who mapped the entire world of products, such as, but not limited to, ISIC (international Standard Industrial Classification) unstats.un.org/unsd/cr/registry/regcstasp?C1=17) or NAICS (North America Industry Classification System www.census.gov/eos/www/naics);
2. Manual definitions as provided by product experts and analysts (for example, an analyst defining residential Wi-Fi routers as a product market);
3. Automatically provided definitions as defined by the system using a system analytical process. This process will examine the ecosystem structure representing the information flow and use graph theory and other network analysis methods to identify separate clusters (or for the present system, ecosystems). This means that the analytic process will identify separate groups of entities that communicate internally within each group and have no or limited communication between the groups. For example, an ecosystem (Product market) with 1000 entities and the information is mainly passed, shared and so on within 2 separate groups of entities. For example 600 entities are communicating (linked) with each other and the other 400 entities are communicating (linked) with each other and there is almost no communication between the members of these two groups, we can analytically understand that there are here two separate districted ecosystems and we should look at them as 2 networks; and
4. Based on the user inputs. This option is in case a user looks at the alternatives but cannot find a sufficient match between the existing product markets and the product market he is interested in. In this case the user will define his/her own product market that can be used by others as well.

The beginning entities list is stored within the storage device 54 of the Web server 50. In accordance with an alternative embodiment of the invention, the beginning entities list may instead be stored at a location remote from the Web server 50 and accessed by the Web server 50. The list of entities within the beginning entities list may be provided by a few types of sources, namely:

1. a user of the present system

2. automatically discovered entities that are part of new ecosystems (as previously mentioned)

3. an expert that describes a new ecosystem.

4. directories and databases that include entity lists of product markets

The user input entity list might be verified with the other alternatives to ensure that all entities on the list are part of the new ecosystem.

As shown by block 206, a footprint of each entered entity within the beginning entities list is followed by a footprint module stored within the software 100 of the web server 50, and associated information is stored. A footprint is information about the entity that can be tracked on the Internet. Such a footprint may include, but is not limited to, identity attributes, activity characteristics, content generation such as, but not limited to, posts and comments, other entities that the initial entity is associated with and so on. Since one having ordinary skill in the art would know how a footprint on the Internet is acquired, further description of the footprint module is not provided herein.

For exemplary purposes, a footprint of John Doe may include: the information that is extracted from conversations that he participated in via the Internet, or in conversations from other people referring to him; the URLs of the blogs where John Doe was mentioned; conferences that John Doe attended on the Internet; and articles that John Doe wrote that are referred to on the Internet. The extracted information can include, but is not limited to: the company that John Doe is working for; his position; the number of posts that he initiated in a month on a specific topic that he is involved in; key words that he is associated with and his relations with other entities. The information extraction may be performed in one of the following ways, although such extraction is not limited to one of these ways of extraction:
Formatted Web pages—these types of Web pages have a structured format so that in each specific part of the Web page there is a specific type of information. An example of such a formatted Web page might be a blog where for each post the author's name is positioned on the top left side of the Web page;
Unformatted Web pages where the information can be placed randomly with no specific structure; and
A free text within formatted Web pages—where some information is placed in designated areas, while other information is part of a free text portion.

In the case of formatted web pages, the information is automatically taken by the Web server 50 from the specific locations on the Web page and then stored on the storage device 54, within the entity list, under the correct entity type. In the case of unformatted Web pages or free text, the Web server 50 uses existing text analysis tools, such as, but not limited to, “Open Calais” (www.opencalais.com), to extract the entity information.

An example of another type of entity could be an event. An example of an event may include the USA Dental Annual Summit. The footprint of an event can be used to collect information regarding the event, such as other entities and attributes associated with the event, which is stored within the storage device 54.

As shown by block 208, each new entity and/or attribute and/or link discovered during following of the entity footprint is run through a qualification process for purposes of validating relevance for a specific ecosystem of the new entity and/or new attribute and/or link. Herein, the qualification process is also referred to as validating relevance. The qualification process enables a determination of the relevance of a newly found entity and/or attribute and/or link to the product market network of the beginning entities list. This qualification process is aimed to decide whether a new suspicious entity (or link) belongs to the ecosystem of the beginning entity list. If the qualification process turns positive, the new entity will join the ecosystem network and will be considered to be a qualified entity.

In accordance with the present invention, a user of the present system would be looking at a specific product market at a time, so the present system, which discovered an entity/attribute/link, will evaluate (qualify) the new entity for the specific product market of interest to the user. As an example, a user of the present system may enter the specific product market of interest from their computer or client station.

The same entity can be found in another ecosystem (of interest to others or to the same user) and evaluated for another product market separately. The same entity may be active in several product markets so that each entity discovered will be qualified to each product market separately. The attributes, links and therefore strength of an entity is defined within a specific ecosystem. Thus, the attributes and links of the entity will be different in a different ecosystem than that which the entity is a member of. For example a person can have a central role in the dog training ecosystem but in the residential Wi-Fi routers ecosystem be can have a very minor role.

Detailed Example for Means of Collecting Information about an Entity

In order to test the relevancy (qualification) of a person suspected to belong to the specific product market, the system will activate a number of tools at the same time to obtain the information about that person. As an example, through PIPLE123, the system will receive the person's personal information (first name, last name, email, title, company, address, profession), using LINKEDIN API the system will get the professional relationships with other people and other entities such as discussion groups, using Zoominfo (a tool for learning about professional relationships)—the system will collect information about that person related companies etc.

Following entity footprints and using the present qualification process provides a growing list of validated entities and/or attributes and/or links associated with the beginning product market network (or the original entity list of the specific product market). The more entities and connections between the entities that are determined by a successful qualification process, the more accurate a resulting model. The more accurate the model, the better the present system and method can uncover the social structure comprehensively and in great details, thus being able to filter and sort content by its relevancy to the ecosystem and recommend to a user activities for improving his/her brand awareness, or any other marketing objectives.

The following further describes the process of validating relevance, or qualifying, of an entity and/or attribute in accordance with the present invention and block 208 of FIG. 4. The process of qualifying is performed by the Web server 50 and includes examining web footprint information collected about a new entity, or new link, arranging this information by fields in the database and then calculating a score for the new entity or new link, and, via the assigned score, determining whether the new entity or link belongs to a specific product market network.

The system scans already obtained conversations stored that belong to the specific product market for related information on a new entity. Moreover, the system monitors new conversations during a pre-defined time period in order to find further information. The information collected (previously called the footprint) is stored in standard attribute fields that describe each type of entity. For example, a person is described by first name, last name, his mails, Job title, company, address, profession, etc. In addition the present invention collects information about the entity's connections with known entities in the specific product market. The system also collects information about the amount and nature of activity this entity has (previously referred to as Volume, Quality, and Stimulation, for example).

Example for Collecting Information for Qualifying Entity

A discussion group is suspected to be part of specific product market. The system checks whether group members are known entities for the specific product market, is there a significant contemporary content (how many relevant conversations were taking place in the group and at what point in time), how the known members active in the group conversations (the amount of LIKE/FOLLOW, amount of comments . . . ), etc.

In accordance with the present invention, there is an on-going process that evaluates all of the information gathered related to a specific entity or link. This evaluation process updates the calculated attributes that can be used, as previously explained, for example, to set the strength of the entity or the link in specific product market, to qualify a new entity or for setting user biased perspective.

For example, in the qualification process, the evaluation process sets the value of several attributes and by this enables to take a decision whether a specific entity belongs to a specific product market. The entity is being graded for all information, connection or activity that the system detected and if the qualification score exceeds a threshold that was determined by the system, then the system defines the entity as known entity (meaning that it does belong to this specific product market). In a second step, the system looks at the links between the new entity and the previously known entities and uses that to update the network structure.

Each record of an entity contains informative attributes and the dynamic, calculated attributes (their values are constantly changing based on new information and the user inputs). The informative attributes include unique identifiers of the entity—for example a specific person details include first name, last name, email, company, job title etc.

The step of validating relevancy of an entity to a specific product market (i.e., the qualification process for new entities) is performed by applying specific functionality, or any type of decision rule, that takes into consideration a number of factors. Examples of such applied specific functionality include: 1. determine if the entity being validated, being from specific product market X, is connected with other entities from specific product market X; 2. determine activity of the entity being validated in social media and whether such activity is consistent with other activity within specific product market X; and 3. consider information attributes related to the entity being validated and their relationship to the product market being considered.

With regard to the specific functionality of determining if the entity being validated is connected with other entities from the specific product market, if an entity being validated is connected to several known product market entities, this is an indication that the entity being validated may be active in this product market, therefore it is relevant to it and is qualified to be part of its social network.

With regard to the specific functionality of activity of the entity being validated, in social media, as an example, if Web posts connected to the entity being validated are about topics and terminology used in this product market, then the entity being validated will get a higher qualification score as it is relevant to this product market. In addition, when an entity is posting content, as an example, a post in a blog that is already a known entity for the system, there is a physical connection between the entity and this blog. These types of physical connections and topic connections will be observed by the system and will be used to update its calculated entity and link attributes (e.g., Volume, Quality and Stimulation, aging—how old is the connection). For a new and suspicious entity, as this calculated attribute becomes higher, so will the relevancy of the attribute be for this product market, and the attribute will receive a higher qualification score. This means that as the information about the new entity is gathered, the calculated attributes are updated, the qualification score is updated and when (and if) this score gets higher than a certain threshold the system will change the entity status from new (suspicious) to qualified. Other decision rules can also be used. With regard to other specific functionality for considering information attributes related to the entity being validated and their relationship to the product market being considered, examples of such information may include, but is not limited to, job title, education, and other attributes that are typical to the member of the specific product market.

It should be noted that the specific functionality provided for purposes of validating relevancy of an entity may be provided by a mathematical formula. Equation 1 provides a non-limiting example of a mathematical formula that may be used to validate relevancy by calculating qualification score.

$$NEQ = \{ {\sum }_{n = 1}^{N} a * NFD ( n ) * ESS ( n ) + b * NNP * TCR + c * NNT * TCR - d * NOT \qquad ( Eq . 1 )$$

In equation
NEQ—New entity qualification score
NFD—Number of new entity's first degree connections with known entities (already qualified to this ecosystem) (first degree is a known social network term that refers to two entities with a direct physical connection. For example, considering two people that are connected, between them is a social network)
n—An index representing a specific known entity that is connected to the new suspicious entity. Total number of known entities=N
ESS—Entity's strength score (for each known entity, n, that is connected to the new, suspicious entity)
NNP—Number of new entity's posts or comments relevant to the specific product market (representing Volume)
TCR—Total conversation relevance (a measure for their relevancy to this product market, based on relevant keyword, or any other indication of relevancy)
NOT—Number of new entity used terms or key words known to be relevant to the product market (representing Quality)
NOT—Number of entities connected to the new entity that is defined by the user as “NOT”.

A, b, c, d—coefficient representing the weight of each component in the equation

This example for calculating the qualification score for a new suspicious entity illustrates how the system can look at the information it obtained about the new entity to assess how connected the new entity is to the existing entities, the attributes of the new entity, and user input that exists.

Each entity, regardless of its type (such as, but not limited, to, location, company, person, association, event/convention, etc.), has a position in the social social-ecosystem. The present system and method describes the social ecosystem by using network analysis methods to calculate the entity location in the network. The strength of an entity, which was explained earlier, represents the entity's own activity and its influence on its immediate neighbors (entities that have direct links to it), but does not represent its role or influence on the network as a whole. The strength represents the entity's local effect, however, we then want to understand its global effect on the entire network. The global influence is not a new concept in social network analysis, and therefore, there is no need to explain the concept in detail herein. Instead, the method of abating the information as explained herein, and how to analyze such information with a multi entity social network is more instrumental to the present system and method. For example, an entity such as a certain blog for instance, can have high strength. The entity is an amplifier, creating and sharing a great deal of content (high Volume). The content tends to be professional and relevant to this ecosystem (high Quality) and there are a good number of comments, likes and shares to its posts (high Stimulation). All of this means that the entity's calculated strength will be high. Nevertheless, this blog can have a large or small influence on the entity's network. Although the strength is high, the information passed through it, may not reach many members of the network. For example, if this blog reaches people that are not amplifying it as their own, strength is low. Another example is the case where there are other amplifiers nearby and the entity's content is already being heard by a reader from another entity. Therefore, the location on the network can represent the global influence of an entity, which is sometimes referred to as “centrality” in Graph theory terminology.

As an example, a graph based network analysis algorithm (graph theory), or similar mathematical calculations, may be used to calculate and illustrate entity positioning within the network. Since one having ordinary skill in the art knows the meaning of graph theory, this is not described in detail herein. For instance, use of the graph theory provides measuring of the specific product market centrality and other known parameters such as degree and proximity of the entity from other entities discovered via use of the footprint and validation steps, in order to determine the role of the entity in the network, how close the entity is to other key entities and how centered it is in the social-ecosystem the entity role as a connector between separate parts of the network and many more.

Centrality (a measurement used in graph analytics) of an entity may be the base for determining which group of entities are the most important for influencing a specific product market. In other words, the most important entities in a product market are the ones with the highest centrality score. The calculation of the centrality score can be done for example by using Betweens Centrality measure, which quantifies the number of times a node acts as a bridge along the shortest path between two other nodes (each node is an entity). This measure is described in detail in Linton Freeman's 1977 article, “A set of measures of centrality based upon betweenness,” of Sociometry 40: 35-41, which is incorporated by reference herein in its entirety. The shortest path (distance) is calculated based on the network structure the system obtained. The distance can be defined, for example, as the number of entities needed to pass through for moving from one entity in a pair of entities to the other. An example of an entity with high centrality in the product market can be a specific company, an important blog, and key people which are highly important for the information flow in the product market of interest. By connecting to these entities, as is enabled by the present system and method, the user can have more influence on the product market. For example, posting content or advertisement on this group of entities will be more effective then to do so in another set of entities. Learning what are the topics discussed in and by these entities can predict what will be of interest to the majority of this market soon.

As new conversations are generated in the network, new entities are detected and qualified while the previously known entities are better evaluated. The present system and method continuously updates the attributes of the entities and their links, add new qualified entities/links and the tool creates a more and more clear and accurate model of the product market social structure. As previously mentioned, the present system also keeps track and discovers new links between every two entities.

The present invention captures both entities' and links' attributes dynamically. Each entity's attributes are re-evaluated based on flow of the new information provided by new conversations that are associated to this entity or based on the user reaction to the list of conversation or recommendation presented to him by the system (for example—mark the conversation for follow-up, add comment on a conversation). The attributes are not just better assessed, they are actually changing with time—people change positions, associations become active in new fields.

Some attributes are values (the calculated attributes). The present invention calculates a value for them based on their Social media activities and the user inputs. As explained for the qualification process of new entities, similar calculations are performed for all of the entities and links in the ecosystem The value is calculated by using several formulas for calculating activity level of an entity (volume of activities in the product market's social media), relevancy and quality of entity's conversations for the product market and how informative it is, and the entity stimulation (what social effect its conversations made in the product market—e.g. how many entities respond or socially act upon its posts).

Attributes are used to better analyze an entity's location in the network the distance between two entities is a fundamental measure in network analysis—the present invention uses the attribute's values to calculate the distance between its entities. In most graphs (network) the distance between two entities is the minimum sum of steps needed to pass through other linked entities to reach to the second entity, while each link has the same length. In some cases each link can have a different length. In the present system and method the length of each link can be calculated using its calculated attributes as described previously by referring to the link strength. The total distance between two entities can also take into consideration the strength of the entities passed though.

A calculated attribute low value means that information flow through the entity towards its neighbor is weaker than if the value was high. It should be noted that the distance from entity A to entity B may be different from the distance from entity B to entity A. It should also be noted that the social-ecosystem is a multi-entity network and different types of entities (e.g. person, discussion group, association, conference, etc.) are allowed to be linked directly.

The present invention reveals which entities are at the center of its product market and which are at the peripheries (see herein with regard to centrality). The product market center includes one or several entities that are at the heart/center of that particular product market. The distances (weighted by the number of links, link attributes, entities strength and entities attributes between each entity and the center of the product market is calculated by the system. The present invention can also measure the distance (also weighted by, the number of entities links and their attributes between any two entities and use it for recommending the user how to better engage with a relevant key entity.

The output is a multi-entity map (using a visualization tool) for the product market social-ecosystem with the entities, the links between the entities and their continuously updated attributes of the entities and/or the links. The model (map) is used for: evaluating and prioritizing social media conversations; generating relevant leads, planning an advertisement or content marketing campaigns and many more marketing activities. Based on the model (map), the tool can suggest marketers' activities to improve the brands position within web based social media.

As shown by block 210, connections, or links, between every two entities (inclusive of validated and beginning entities) are examined by the Web server 50, and if the links exist, the Web server 50 determines the model (structure) of the product market network. The calculation of the product market network model is based on mathematical structures used to model pairwise relations between objects from a certain collection. A present model in this context is a collection of entities and the links between them. The visualization of the model allows pointing out of the network map, which represents the information flow within a specific product market and the main information hubs (or junctions) of this market. By using many network analysis and visualization and graph theory tools the exploration of the data can be done also through displaying the entities and their links in various layouts, and attributing colors, size and other advanced properties to entities, attributes and their links.

The links between the entities have attributes, similar to the entities, namely, informative and calculated attributes. The link attributes are calculated in a way similar to the entity attributes, only the system refers only to information flow between the two entities. For example the Volume of the link is calculated based only on activities (post, comment, like, share) between the specific two entities. The connection (link) strength is the mathematical result coming from taking several elements, such as, the calculated attributes of the link. Again, calculating a better model with more and better evaluated links that represent the information flow on the specific product market network, as performed by the present system and method, results in better filtering, and more relevant recommendations, etc.

There might be different weights to link attributes in the mathematical formulas for calculating link strength score with comparison to entity strength score. Therefore, determining the number of links to an entity is only part of the process of calculating its strength, as there are other functions performed including determining the number and strength of links to major entities in the specific product market network. Herein, major entities are entities that have a high entity strength score, which results from having a high calculated attribute value and a high number of strong links to other strong entities.

### System Initiated Search Using External Tools

The following further elaborates upon the situation where the user creates its own product market that can be used by others as well. In this situation, the system is feed with social media information so that the system can perform information extraction. In accordance with the present invention, the Web server 50 initiates a search using either external tools or a direct connection to Internet locations in order to obtain more information, such as adding suspected entities, updating existing entity's attributes, adding suspected new links or updating existing links' attributes.

### EXAMPLES

The system initiates a search using a harvesting tool (for example Trackur, the online reputation & social media monitoring tool), search databases (such as Hoovers), regular search engines such as Bing, or finds the entity in known discussion groups, for purposes of finding information about the entity (i.e., its footprint). The information collected is stored within the storage device 54, in standard attribute fields that describe each type of entity (there are different attributes for different entity types).

For example, if the new added entity is a person, the system may look for his job title, profession, etc. In addition, the system may collect information about his connections (links) with known entities on the specific product market (e.g., in what blogs, discussion groups, YouTube channels, he is contributing, in which conferences he was a speaker, etc.). The system will also evaluate few criteria about the entity's social media volume of activity, quality of content and the stimulation it has on the specific product market.

As shown by block 212, if a newly found entity or entity's attribute is determined to be relevant, the entity or attribute is stored within the storage device 54. Specifically, the present system stores the entities including their attributes and the links between the entities and their attributes. The entire information is actually the model (presented as a network) for a specific product market.

In accordance with the present invention, new entities are then added to the list of suspected entities to be monitored, thereby expanding the information and contacts gathered within the beginning product market (block 214), and thus continually expanding the network side and accuracy (more entities and links and more updated attributes). The monitoring process includes the process of following a footprint of each new entity and determining relevance of each additional entity encountered while following the footprint of each new entity. This process is continued to add more entities, links, and attributes.

As previously mentioned, the present system tracks the activities of each entity over the Web in order to dynamically further evaluate their attributes, links, and bring new entities and links related to them.

The relevance (also referred to previously as strength) of the entities is determined. As is explained in further detail herein below, the present system then calculates the role and network location of each entity in the specific product market, including the beginning entities and all other entities that have been found and passed qualification.

It should be emphasized that the above-described embodiments of the present invention are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

We claim:

1. A system for improving effectiveness of internet marketing, comprising:
a memory; and
a processor configured by the memory to perform the steps of
assuming that all entities within a beginning entity list are from a first social product market network;
determining information about at least one entity of the beginning entity list that can be tracked on the Internet by following a footprint of the at least one entity;
running a qualification process on each new entity, attribute, and/or link discovered during following of the footprint of the at least one entity of the beginning entity list to validate relevance of the new entity, attribute, and/or link discovered to the product market network of the beginning entity list; and
storing entities, attributes, and/or links determined to be relevant during the step of running a qualification process.

2. The system of claim 1, wherein the system is a Web server.

3. The system of claim 1, wherein the step of running a qualification process further comprises the steps of:
arranging the determined information about the at least one entity that can be tracked on the Internet by fields;
calculating, a score for each new entity or link discovered during following of the footprint of the at least one entity; and
via the calculated score, determining whether each new entity or link belongs to the first social product market network.

4. The system of claim 3, wherein the step of calculating a score for each new entity is performed by using the equation
$$NEQ = \{ {\sum }_{n = 1}^{N} a * NFD ( n ) * ESS ( n ) + b * NNP * TCR + c * NNT * TCR - d * NOT ,$$
where NEQ is a new entity qualification score, NFD is a number of new entity's first degree connections with known entities already qualified to the first specific product market network, n is an index representing a specific known entity that is connected to the new entity, N is a total number of known entities, ESS is the entity's strength score for each known entity, n, that is connected to the new entity, NNP is the number of new entity's posts or comments relevant to the first social product market, TCR is a total conversation relevance, which is a measure for the new entity's relevancy to this product market, based on relevant keyword, or any other indication of relevancy, NNT is a number of new entity used terms or key words known to be relevant to the first social product market network, NOT is a number of entities connected to the new entity that is defined by as “NOT”, and a, b, c, d are coefficients representing the weight of each component in the equation.

5. The system of claim 1, wherein the information about the at least one entity is selected from the group consisting of identity attributes, activity characteristics, content generated and other entities that the at least one entity list entity is associated with.

6. The system of claim 1, wherein the step of determining information about the at least one entity includes determining a social role of the at least one entity, which is a combination of more than one of the list consisting of entity activity, volume in social media, quality of information the entity creates, and the stimulation the entity produces on other entities in the first social product market network.

7. The system of claim 1, wherein the step of running a qualification process on each new entity is performed by applying functionality that takes into consideration at least one factor from the group consisting of determining if the new entity being validated, being from product market X, is connected with other entities from product market X, determining activity of the new entity being validated in social media and whether such activity is consistent with other activity within the first social product market network, and considering information attributes related to the new entity being validated and their relationship to the first social product market network.

8. The system of claim 1, wherein the processor is further configured by the memory to perform the step of examining links between every two entities.

9. The system of claim 1, wherein the step of determining information about the new entity further comprises determining attributes of the new entity, wherein the attributes may be selected from the group consisting of informative attributes, which provide information on the new entity, and calculated attributes, which describe strength or value of the new entity in the first social product market network.

10. The system of claim 1, wherein the entities within the beginning entity list include entities of more than one type.

11. The system of claim 1, wherein the entities within the beginning entity list and the new entities include entities of more than on type.

12. The system of claim 1, further comprising the steps of:
determining information about the new entity by tracking the information on the Internet and following a footprint of the new entity; and
running a qualification process on each additional new entity, attribute, and/or link discovered during following of the footprint of the new entity.

13. The system of claim 1, further comprising the step of using a graph based network analysis algorithm to calculate and illustrate positioning of the at least one entity within the first social product market network.

14. A method of improving effectiveness of Internet marketing, comprising the steps of:
assuming that all entities within a beginning entity list are from a first social product market network;
determining information about at least one entity of the beginning entity list that can be tracked on the Internet by following a footprint of the at least one entity; and
running a qualification process on each new entity, attribute, and/or link discovered during following of the footprint of the at least one entity of the beginning entity list to validate relevance of the new entity, attribute, and/or link discovered to the product market network of the beginning entity list.

15. The method of claim 14, further comprising the step of storing entities, attributes, and/or links determined to be relevant during the step of running a qualification process.

16. The method of claim 15, wherein the step of running a qualification process further comprises the steps of
arranging the determined information about the at least one entity that can be tracked on the Internet by fields;
calculating a score for each new entity or link discovered during following of the footprint of the at least one entity; and
via the calculated score, determining whether each new entity or link belongs to the first social product market network.

17. The method of claim 15, wherein the information about the at least one entity is selected from the group consisting of identity attributes, activity characteristics, content generated and other entities that the at least one entity list entity is associated with.

18. The method of claim 15, wherein the step of determining information about the at least one entity includes determining a social role of the at least one entity, which is a combination of more than one of the list consisting of entity activity, volume in social media, quality of information the entity creates, and the stimulation the entity produces on other entities in the first social product market network.

19. The method of claim 15, wherein the step of running a qualification process on each new entity is performed by applying functionality that takes into consideration at least one factor from the group consisting of determining if the new entity being validated, being from product market X, is connected with other entities from product market X, determining activity of the new entity being validated in social media and whether such activity is consistent with other activity within the first social product market network, and considering information attributes related to the new entity being validated and their relationship to the first social product market network.

20. The method of claim 15, further comprising the step of examining links between every two entities.

21. The method of claim 15, wherein the step of determining information about the new entity further comprises determining attributes of the new entity, wherein the attributes may be selected from the group consisting of informative attributes, which provide information on the new entity, and calculated attributes, which describe strength or value of the new entity in the first social product market network.

22. The method of claim 15, wherein the entities within the beginning entity list include entities of more than one type.

23. The method of claim 15, wherein the entities within the beginning entity list and the new entities include entities of more than on type.

24. The method of claim 15, further comprising the steps of:
determining information about the new entity by tracking the information on the Internet and following a footprint of the new entity; and
running a qualification process on each additional new entity, attribute, and/or link discovered during following of the footprint of the new entity.

25. The method of claim 15, further comprising the step of using a graph based network analysis algorithm to calculate and illustrate positioning of the at least one entity within the first social product market network.
